(19) United States
(12) Patent Application Publication
(10) Pub. No.: US 2004/0114875 A1
(43) Pub. Date: Jun. 17, 2004

(54) 90 Degree fiber optic board connector

(76) Inventor: Randy Mattsen, Rochester, MN (US)

Correspondence Address: Sandra P. Thompson, Riordan & McKinzie, 600 Anton Blvd., 18th Floor, Costa Mesa, CA, 92626, US

(21) Appl. No.: 10/322,407

(22) Filed: Dec. 17, 2002

(51) Int. Cl. G02B 6/36

(52) U.S. Cl. 385/53; 385/88

(57) ABSTRACT

Connectors and methods for optically connecting two or more optical boards are described. In particular, described are optical connectors comprising a plurality of parallel, curved channels are described, as are assemblies with which such connectors may be used, methods that may be used to produce such connectors, and methods of using such connectors.

### FIELD OF THE INVENTION

The field of the invention is optical boards.

### BACKGROUND OF THE INVENTION

An optical board, as the term is used herein, is a board (possibly a printed wiring board) or other support structure that comprises one or more optical waveguides. An optical waveguide is a structure that “guides” a light wave by constraining it to travel along a certain desired path. A waveguide traps light by surrounding a guiding region, called the core, with a material called the cladding, where the core is made from a transparent or translucent material with higher index of refraction than the cladding.

In some instances, the optical waveguides of an optical board will include one or more surface traces, such traces frequently comprising an optical resin deposited on a substrate to form a ridge waveguide. In some instances an optical board may comprise a plurality of parallel traces

### SUMMARY OF THE INVENTION

The present invention is directed to connectors and methods for optically connecting two or more optical boards. In particular, optical connectors comprising a plurality of parallel, curved channels are described, as are assemblies with which such connectors may be used, methods that may be used to produce such connectors, and methods of using such connectors.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is an exploded perspective view of a first assembly embodying the invention, the assembly including a first optical connector.

FIG. 2 is a perspective view of the optical connector of FIG. 1 in assembled form.

FIG. 3 is an assembled perspective view the assembly of FIG. 1.

FIG. 4 is a cutaway side view of the assembly of FIG. 1.

FIG. 5 is a cutaway side view of a second assembly embodying the invention.

FIG. 6 is a cutaway side view of a third assembly embodying the invention, the assembly including a third optical connector coupling two optical boards.

FIG. 7 is a cutaway side view of a forth assembly embodying the invention, the assembly including a forth optical connector coupling two layers of optical traces.

FIG. 8 is a cutaway side view of a fifth assembly embodying the invention, the assembly including a fifth optical connector.

FIG. 9 is a cutaway side view of a sixth assembly embodying the invention, the assembly including a sixth optical connector.

FIG. 10 is a perspective view of a seventh optical connector embodying the invention.

### DETAILED DESCRIPTION

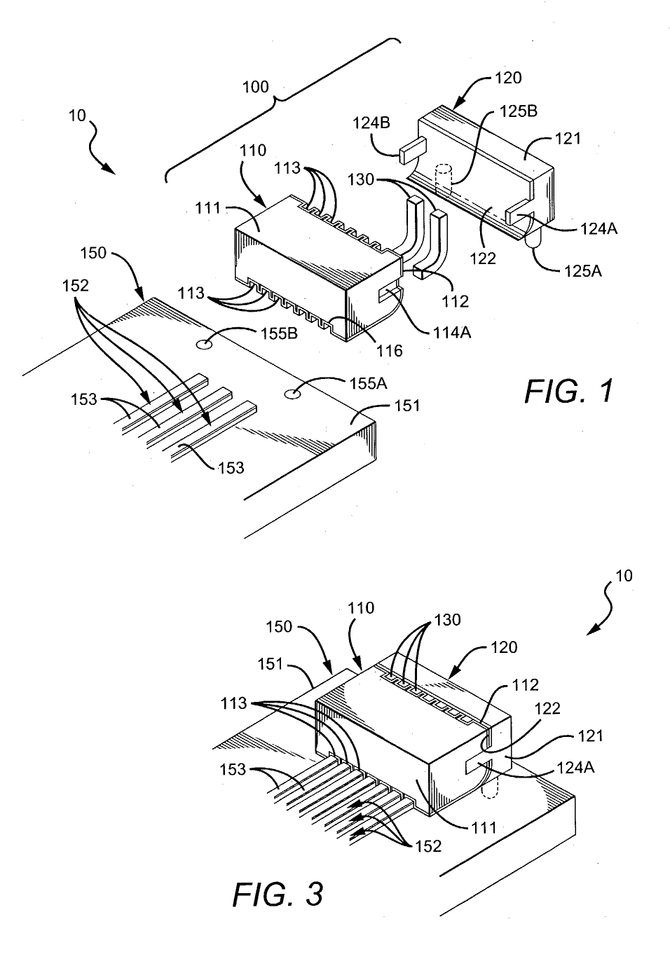

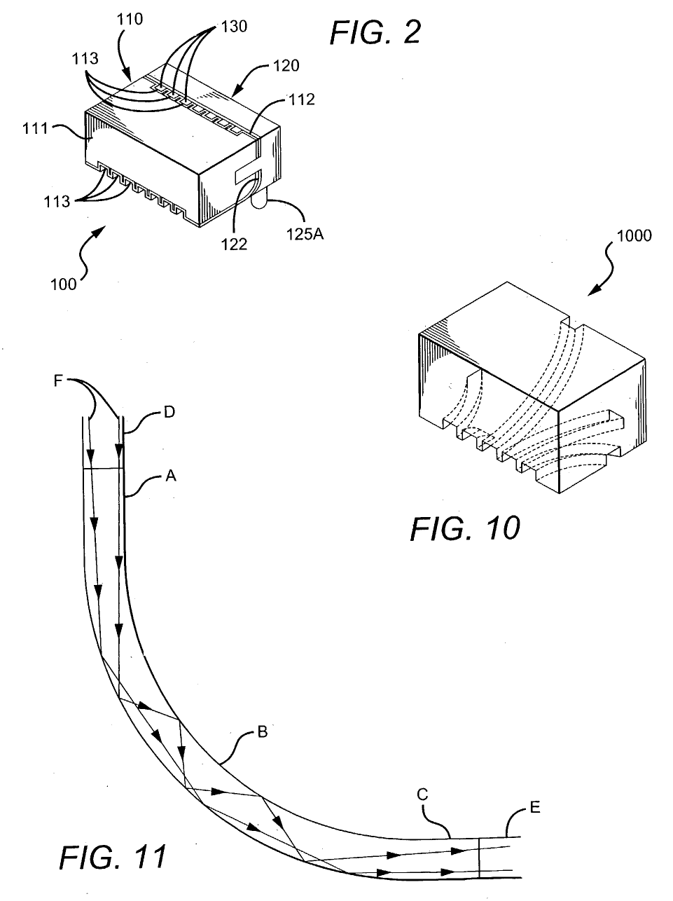

Referring to FIGS. 1-4, an assembly 10 comprises an optical connector 100 and an optical board 150. Optical connector 100 comprises optical channel housing 110, reflector block 120, and optical medium 130. Optical channel housing 110 comprises body 111, reflector block mating surface 112, optical channels 113, alignment member receiving portions 114A and 114B, and channel cladding 116. Optical channels 113 comprise linear segments 113A and 113C coupled by a curved segment/bend 113B. Reflector block 120 comprises body 121, reflective surface 122, and alignment members 124A, 124B, 125A, and 125B. Optical medium 130 comprises a transparent or translucent material such as an optical resin. Optical board 150 comprises substrate 151, optical traces 152, optical trace cladding 153, and alignment member receiving portions 155A and 155B.

As can be seen from the figures, optical connector 100 is an optical connector adapted to be coupled to at least one core of an optical waveguide, in this embodiment optical traces 152, of an optical board such as board 150. Once coupled to board 150, optical connector 100 re-directs light passing through optical traces 152, typically away from board 150. Coupling connector 100 to board 150 may simply comprise providing the various pieces of connector 100, assembling connector 100, positioning connector 100 on board 150 such that channels 113 are aligned with traces 152, and filling channels 113 with an optical medium 130 such as a resin. The medium 130 should optically contact traces 152 such that light passing through traces 152 will also pass through medium 130.

Optical connector 100 is adapted to be coupled to the optical traces 152 of board 150 in a number of ways. One such is that channels 113 are left open along part of their length such ends of traces 152 can be inserted into ends of channels 113. Another way is that the width of and spacing between channels 113 is chosen to allow multiple traces 152 to be aligned with and fit within multiple channels 113. Another adaptation that facilitates coupling, in particular the alignment of channels 113 with traces 152, is the use of alignment members 125A and 125B which, in the embodiment shown, are pins to be inserted into holes 155A and 155B of board 150. Members 125A and 125B as shown are part of reflector body 120. As such, additional alignment members 124A and 124B are used to align channel housing 110 with reflector body 120 which subsequently permits alignment members 125A and 125B to align channels 113 with traces 152. Yet another adaptation for coupling is that the surface of the connector 100 that contacts board 150 is the same shape (in this instance simply flat) as the surface of board 152.

It is contemplated that different embodiments of optical connector may be coupled to optical boards in different manners. FIGS. 1-4 illustrate coupling a connector to the same surface of an optical board as the optical traces are coupled to. FIG. 5, however, shows a connector coupled to an end of an optical board. It is contemplated that any method of coupling a connector to a board may be used so long as light passing through optical waveguides on the boards may be successfully transmitted through the connector. Coupling will generally involve bonding the connector to the board through the use of a bonding material such as an adhesive, and/or may involve the use of connecting and/or alignment members that lock the connector to a board.

Referring to FIG. 5, an assembly 50 comprises an optical connector 500 and an optical board 550. Optical connector 500 comprises optical channel housing 510, reflectorblock 520, and optical medium 530. Optical channel housing 510 comprises body 511, reflector block mating surface 512, optical channels 513, and channel cladding 516. Reflector block 520 comprises body 521, reflective surface 522, and alignment member 525A. Optical medium 530 comprises a transparent or translucent material such as an optical resin. Optical board 550 comprises substrate 551, optical traces 552, optical trace cladding 553, and alignment member receiving portion 555A.

Coupling the cores of an optical connector as described herein to the waveguide cores of an optical board may be done in a number of ways. The choice of a method of connection will be based, at least in part, on whether the optical channels (such as channels 113) are pre-filled or not. The optical channels will generally be fully pre-filled, completely unfilled, or partially pre-filled prior to coupling. In the instance where the optical channels are fully pre-filled, the optical connector will need to be positioned adjacent to the cores (such as traces 152) of the optical waveguides as shown in FIGS. 5 and 6, with an optical resin being used to couple the pre-filled cores of the optical channels with the cores of the optical board. In the instance where the optical channels are completely unfilled or partially pre-filled, the optical connector can be placed either adjacent to or on top of the board's optical waveguide cores, with an optical medium such as a resin being injected into the unfilled portions of the channels after the connector is properly positioned.

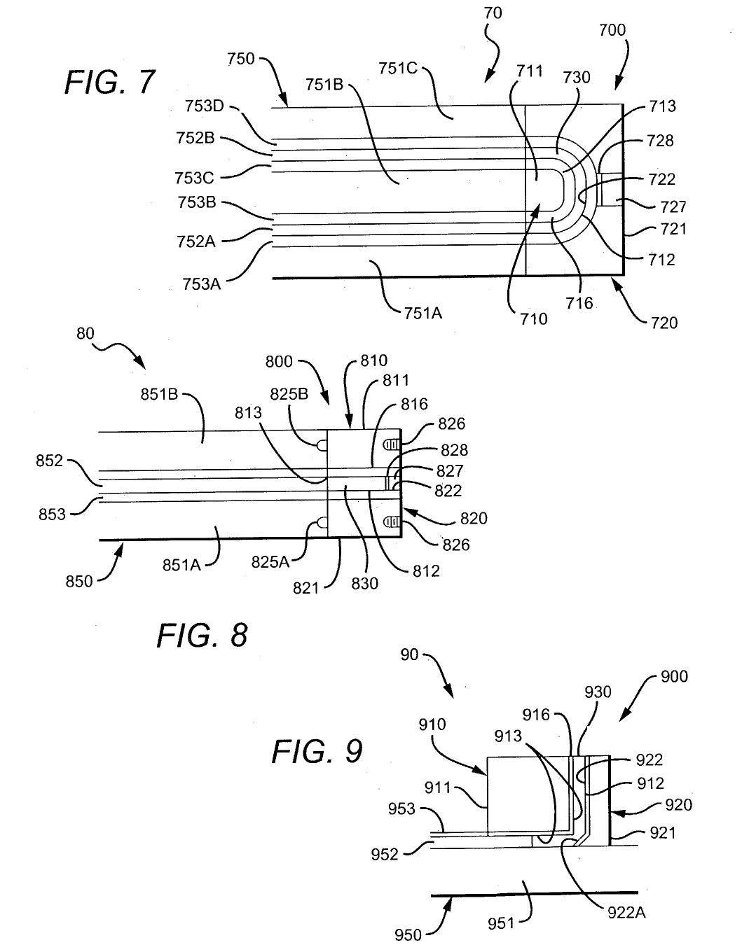

In some instances, filling the optical channels of a connector may involve the use of an inlet other than the channels themselves. Such an instance is illustrated in FIG. 7 which comprises a plug 727 that can be left out or removed for filling channels 713 through the hole filled by the plug and subsequently be inserted to close the hole and, preferably, to complete the reflective cladding of the channels.

It is contemplated that optical connectors as described herein may be used, among others, to couple multiple optical boards together. Referring to FIG. 6, an assembly 60 comprises an optical connector 600 and an optical boards 650A and 650B. Optical connector 600 comprises optical channel housing 610, reflector block 620, and optical medium 630. Optical channel housing 610 comprises body 611, reflector block mating surface 612, optical channels 613, and channel cladding 616. Reflector block 620 comprises body 621 and reflective surface 622. Optical medium 630 comprises a transparent or translucent material such as an optical resin. Optical boards 650A and 650B each comprise a substrate (651A and 651B), optical traces (652A and 652B), and optical trace cladding (653A and 653B).

It is also contemplated that the optical connectors described herein may be used to transmit light between optical boards and other non-board devices such as other optical connectors. FIG. 8, described in more detail below, illustrates such an embodiment.

The cross sectional shape of the optical paths may vary between embodiments of connectors, or even between paths of a single connector. Any shape that passes light through the connector may be used, but symmetrical shapes are preferred as is uniformity along the length of the paths. It is contemplated that most embodiments will utilize optical paths that have a circular, square, or rectangular cross-sectional shape.

Similarly, the overall shape of the optical channels will likely vary between embodiments. Once again, it is contemplated that virtually any shape that may be used so long as the optical paths pass light through the connector. Examples of various shaped paths are provided in FIGS. 7-9 as an alternative to the preferred shape of FIGS. 1-6. It should be understood that the examples shown do not illustrate all of the contemplated shapes.

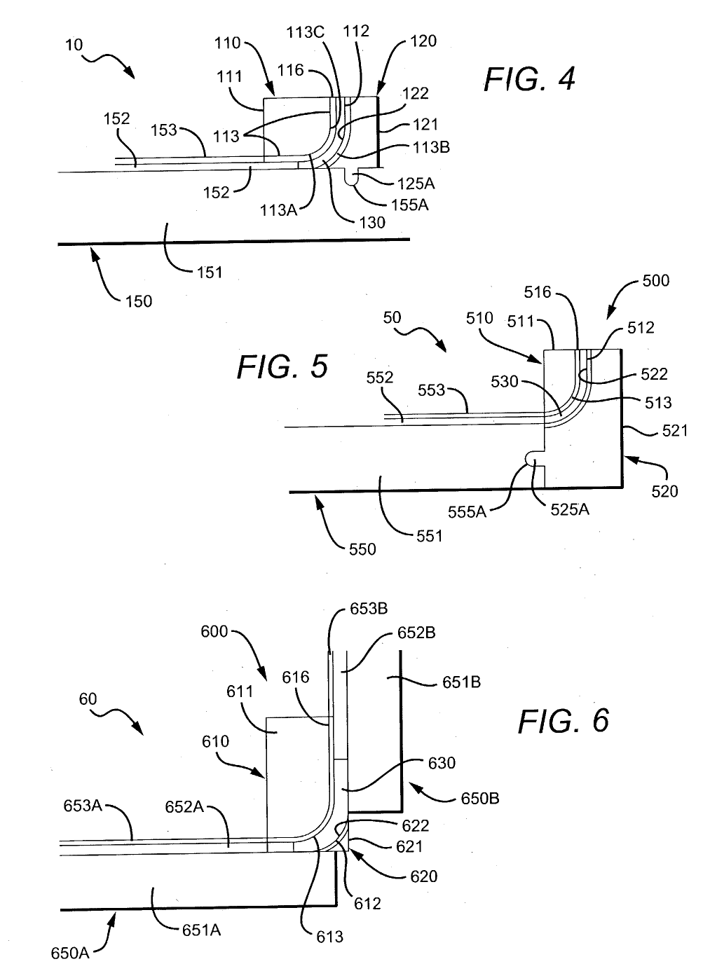

The preferred shape of the optical paths in a connector comprises an arc coupling two linear segments together. Referring to FIG. 4, it the cross section of channel 113 shows that it has linear ends 113A and 113C, and arced segment 113B. Similarly, in FIG. 11 linear segments A and C of a connector optical waveguide are coupled by arced segment B, the waveguide being optically coupled to external waveguide cores D and E. Light F passing through external waveguide D, through segments A and B, and out segment C into core E. In some instances the linear portions of the connector path will be at least partially filled by the cores the connector is being coupled to. Although embodiments may utilize variations of the preferred shape, it is contemplated that connectors may benefit from the use of optical paths having linear segments that are between 0.0 and 0.125 inches long, and an arced segment measuring between 30 and 135 degrees (most preferably 90 degrees), and having a radius between 0.06 and 0.200 inches. In many instances, linear segments at opposite ends of an optical path will be perpendicular to each other.

It is contemplated that having linear ends 113A and 113B is particularly well suited to coupling a connector to linear traces on a board as it permits the traces to be inserted into ends 113A or 113B. It is contemplated that the use of an arced segment rather than an elliptical or angled segment to re-direct light provides for decreased energy losses as light passes through the connector.

In FIG. 7, “U” shaped optical paths are used to couple multiple layers of optical traces in a multi-layer optical board together. Connector 700 in this instance end connector coupled to an end/side of board 750. Referring to FIG. 7, an assembly 70 comprises an optical connector 700 and an optical board 750. Optical connector 700 comprises optical channel housing 710, reflector block 720, and optical medium 730. Optical channel housing 710 comprises body 711, reflector block mating surface 712, optical channels 713, and channel cladding 716. Reflector block 720 comprises body 721 and reflective surface 722. Reflector block 720 also comprises plug 727 having a reflective surface 728. Optical medium 730 comprises a transparent or translucent material such as an optical resin. Optical board 750 comprises layers 751A-751C, optical traces 752A and 752B, and optical trace cladding 753A-753D.

In FIG. 8, a linear or “pass through” connector is coupled to and end of board 850. It is contemplated that such a connector may be facilitate optically coupling something other than an optical board to optical board 850. Such a connector may include various coupling mechanisms such as screw holes 826 to facilitate coupling a second optical connector (not shown) to optical connector 800. In FIG. 8, assembly 80 comprises an optical connector 800 and an optical board 850. Optical connector 800 comprises optical channel housing 810, reflector block 820, and optical medium 830. Optical channel housing 810 comprises body 811, reflector block mating surface 812, optical channels 813, and channel cladding 816. Reflector block 820 comprises body 821 and reflective surface 822. Reflector block 820 also comprises plug 827 having a reflective surface 828. Connector 800 also comprises alignment members 825A and 825B. Optical medium 830 comprises a transparent or translucent material such as an optical resin. Optical board 850 comprises layers 851A and 851B, optical traces 852, and optical trace cladding 853.

Although preferred embodiment will utilize arced channels to re-direct light, it is contemplated that less preferred embodiments will utilize non-arced channels such as the channel shown in FIG. 9 which comprises a forty-five degree angled surface to pass light between perpendicular segments rather than using a bend having an arc shape. In FIG. 9, an assembly 90 comprises an optical connector 900 and an optical board 950. Optical connector 900 comprises optical channel housing 910, reflector block 920, and optical medium 930. Optical channel housing 910 comprises body 911, reflector block mating surface 912, optical channels 913, and channel cladding 916. Reflector block 920 comprises body 921 and reflective surface 922. Reflective surface 922 comprises angled portion 922A. Optical medium 930 comprises a transparent or translucent material such as an optical resin. Optical board 950 comprises substrate 951, optical traces 952, and optical trace cladding 953.

It is contemplated that alternative embodiments may utilize a connector comprising a unitary body as shown in FIG. 10 rather than the two or more piece connectors of FIGS. 1-9. Such a connector would have one or more optical channels passing through it, each of the optical channels comprising walls clad with a reflective material. Use of such a connector would typically involve coupling the connector to an optical board and using an optical resin to couple the connector to optical traces on the board.

It is also contemplated that a connector may comprise a plurality of optical channels where not all of the channels re-direct light in the same fashion. As an example, connector 1000 of FIG. 10 comprises six optical channels, with each optical channel re-directing light in a different direction and out of a different surface than each of the other optical channels.

The actual method used to manufacture connectors as described herein will likely also vary, and essentially any method producing a connector having desirable characteristics may be used. One contemplated method involves: (a) providing an optical channel housing comprising a plurality of open channels, the channels having walls coated with a reflective material; (b) providing a reflector block comprising at least one reflective surface; (d) coupling the reflector block to the optical channel housing such that the at least one reflective surface encloses at least portions of the plurality of open channels; and (e) filling at least the enclosed portions of the plurality of open channels with an optical resin. The provided optical channel housing may include a reflector block contacting surface from which the plurality of open channels extend into the housing, with the reflector block reflective surface being shaped to mate with the reflector block contacting surface such that coupling the reflector block to the optical channel housing involves placing the reflective surface in contact with the reflector block contacting surface.

The optical channel housing may be formed by injection molding or other means to form the body of the housing with the body including the channels, and the supporting surface that is the portion of the body that will underlie the reflector block contacting surface. Such a body could then be plated on the channel walls and the supporting surface. Although plating the supporting surface is not necessary, plating the supporting surface at the same time the channels are plated may simplify the plating process. Similarly, the reflector block may be formed by injection molding or other means to form the body of the block, and then plating the portion of the block that will underlie the reflective surface of the block. Optical medium 130 may be formed by injection or other means such that the connector optical paths shape the medium, or may be pre-formed and inserted into the connector.

The actual choice of materials used to form a connector as described will likely very between embodiments. However, it is contemplated that the use of plastic or aluminum for the optical channel housing and reflector block bodies, and an optical resin as the reflective medium may be particularly advantageous.

Thus, specific embodiments and applications of optical connectors and optical board assembly, and methods relating to same, have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. An optical connector adapted to be coupled to at least one optical trace of an optical board.

2. The connector of claim 1 comprising at least one trace receiving channel sized and dimensioned to receive a portion of the at least one optical trace.

3. The connector of claim 2 wherein the at least one trace receiving channel is elongated and comprises a first end and a second end, wherein the channel comprises a bend between the first end and the second end, and at least one linear segment coupled to the bend.

4. The connector of claim 3 wherein the bend comprises an arc.

5. The connector of claim 4 wherein the first end is perpendicular to the second end.

6. The connector of claim 5 wherein the arc has a central angle measuring ninety degrees, and the at least one linear segment has a length of not more than 0.125 inches.

7. The connector of claim 6 wherein the connector comprises at least two linear segments coupled to opposite ends of the arc, and each linear segment has a length of not more than 0.125 inches.

8. The connector of claim 7 wherein the at least one trace receiving channel comprises at least four trace receiving channels.

9. The connector of claim 3 wherein the at least one linear segment is open along at least part of its length, and the bend is fully enclosed by the connector.

10. An optical connector comprising:
an optical channel housing comprising at least one optical channel;
a reflector block coupled to the optical channel housing, the reflector block comprising a reflective surface, a portion of the reflective surface being a wall or portion of a wall of the at least one channel.

11. The connector of claim 10 comprising an alignment mechanism adapted to align the optical channel housing and the reflector block to each other.

12. The connector of claim 11 wherein the connector consists essentially of the optical channel housing, the reflector block, and an optical resin filling at least a portion of each of the at least one optical channels.

13. A method of forming a connector comprising:
providing an optical channel housing comprising a plurality of open channels, the channels having walls coated with a reflective material;
providing a reflector block comprising at least one reflective surface;
coupling the reflector block to the optical channel housing such that the at least one reflective surface encloses at least portions of the plurality of open channels;
filling at least the enclosed portions of the plurality of open channels with an optical resin.

14. The method of claim 13 wherein:
the optical channel housing comprises a reflector block contacting surface from which the plurality of open channels extend into the housing;
the reflector block at least one reflective surface is sized and shaped to mate with the reflector block contacting surface; and
coupling the reflector block to the optical channel housing comprises placing the reflective surface in contact with the reflector block contacting surface.

15. The method of claim 14 further comprising:
providing an optical board comprising at least one optical trace coupled to a substrate;
coupling the optical connector to the optical board such that a portion of the at least one optical trace fits within an exposed and unfilled portion of the at least one optical channel with the substrate enclosing the portion of the at least one trace within the previously exposed and unfilled portion of the at least one optical channel;
filling a portion of the at least one optical channel with an optical resin such that the resin contacts the at least one optical trace.

16. A method of coupling an optical connector to an optical board comprising:
providing an optical connector, the connector having at least one optical channel, a portion of the at least one optical channel being at least partially exposed and unfilled;
providing an optical board comprising at least one optical trace coupled to a substrate;
coupling the optical connector to the optical board such that a portion of the at least one optical trace fits within an exposed and unfilled portion of the at least one optical channel with the substrate enclosing the portion of the at least one trace within the previously exposed and unfilled portion of the at least one optical channel;
filling a portion of the at least one optical channel with an optical resin such that the resin contacts the at least one optical trace.

17. The method of claim 16 wherein the optical trace is an at least partially unclad ridge waveguide.

18. The method of claim 17 wherein filling a portion of the at least one optical channel comprises filling any open volumes of the channel.
